(19) United States
(12) Patent Application Publication
(10) Pub. No.: US 2026/0164322 A1
(43) Pub. Date: Jun. 11, 2026

(54) ACQUIRING TIMING ADVANCE (TA) INFORMATION FOR A CANDIDATE CELL USING SOUNDING REFERENCE SIGNALS (SRS)

(71) Applicant: QUALCOMM Incorporated, San Diego, CA (US)

(72) Inventors: Fang Yuan, Beijing (CN); Yan Zhou, San Diego, CA (US); Jelena Damnjanovic, Del Mar, CA (US); Tao Luo, San Diego, CA (US)

(21) Appl. No.: 19/123,948

(22) PCT Filed: Dec. 23, 2022
(86) PCT No.: PCT/CN2022/141323

§ 371 Date: Apr. 24, 2025

(51) Int. Cl. H04W 36/08; H04L 5/00; H04W 56/00; H04W 72/231; H04W 76/20

(52) U.S. Cl. CPC H04W 36/08; H04L 5/0051; H04W 56/0045; H04W 72/231; H04W 76/20

(57) ABSTRACT

This disclosure provides systems, methods, and devices for wireless communication that support acquiring TA information for a candidate cell using an SRS. In a first aspect, user equipment (UE) may receive an indication of a candidate cell. For example, the UE may be transitioning from communicating with an active cell to the candidate cell. The UE may determine, based on a sounding reference signal (SRS) set, timing advance (TA) information for communication with the candidate cell and may transmit, to the candidate cell, an SRS that includes the TA information. Other aspects and features are also claimed and described.

### TECHNICAL FIELD

Aspects of the present disclosure relate generally to wireless communication systems, and more particularly, to acquiring timing advance (TA) information. Some features may enable and provide improved communications, including acquiring TA information for a candidate cell using sounding reference signal (SRS) in L1 and L2 mobility.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, the techniques described herein relate to a method of wireless communication performed by a user equipment (UE), the method including receiving an indication of a candidate cell, wherein the UE is transitioning from communicating with an active cell to the candidate cell; determining, based on a sounding reference signal (SRS) set, timing advance (TA) information for communication with the candidate cell; and transmitting, to the candidate cell, an SRS that includes the TA information.

In some aspects, the techniques described herein relate to a method of wireless communication performed by a first base station, the method including receiving an indication of a UE, wherein the UE is transitioning from communicating with a second base station to the first base station; determining, based on a sounding reference signal (SRS) set, timing advance (TA) information for communication with the UE; and transmitting, to the UE, an SRS that includes the TA information.

In some aspects, the techniques described herein relate to a user equipment (UE) that includes a memory storing processor-readable code and at least one processor coupled to the memory. The at least one processor may be configured to execute the processor-readable code to cause the at least one processor to: receive an indication of a candidate cell, wherein the UE is transitioning from communicating with an active cell to the candidate cell; determine, based on a sounding reference signal (SRS) set, timing advance (TA) information for communication with the candidate cell; and transmit, to the candidate cell, an SRS that includes the TA information.

In some aspects, the techniques described herein relate to a first base station that includes a memory storing processor-readable code and at least one processor coupled to the memory. The at least one processor may be configured to execute the processor-readable code to cause the at least one processor to: receive an indication of a UE, wherein the UE is transitioning from communicating with a second base station to the first base station; determine, based on a sounding reference signal (SRS) set, timing advance (TA) information for communication with the UE; and transmit, to the UE, an SRS that includes the TA information.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example wireless communication system that supports acquiring TA information for a candidate cell using an SRS according to one or more aspects.

FIG. 4 is a flow diagram illustrating an example process that supports a acquiring TA information for a candidate cell using an SRS according to one or more aspects.

FIG. 5 is a block diagram of an example UE that supports acquiring TA information for a candidate cell using an SRS to one or more aspects.

FIG. 6 is a flow diagram illustrating an example process that supports acquiring TA information for a candidate cell using an SRS according to one or more aspects.

FIG. 7 is a block diagram of an example base station that supports acquiring TA information for a candidate cell using an SRS according to one or more aspects.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support acquiring TA information using SRSs, which may be received from one or more cells in L1/L2 mobility scenario. In particular, a UE may transition between one or more cells, such as one or more primary cells (PCells), secondary cells (SCells), Primary and Secondary Cells (PSCells), special cells (SpCells), or combinations thereof. When switching in this context, it may be necessary to exchange updated information for the new cell. In particular, it may be necessary to determine TA information, transmit power information, beam management information, and combinations thereof. Mechanisms for determining this information may need to be compatible with L1/L2 signal used to update the cells for a UE, along with other interface signaling. For example, R18 systems for L1/L2 signaling may specify mechanism and procedures of L1/L2 based inter-cell mobility for mobility latency reduction. Such systems may be used to configure and maintain multiple candidate cells to allow fast application of configurations for candidate cells and may include a dynamic switch mechanism among candidate serving cells (including SpCells and SCells) based on L1/L2 signaling. L1 enhancements for inter-cell beam management may include L1 measurement and reporting and beam indication, TA management, and interface signaling (such as Central Unit (CU)-distributed unit (DU) signaling) to support L1/L2 mobility, if needed. Accordingly, L1/L2 based inter-cell mobility may be applicable to the following scenarios (i) standalone, carrier aggregation (CA), and New Radio-Dual Connectivity (NR-DC) cases with serving cell change within one cell group (CG), (ii) Intra-DU cases and intra-CU/inter-DU cases, (iii) intra-frequency and inter-frequency cases in which source/active cells and target cells are synchronized or non-synchronized.

One solution to this problem may be to acquire initial TA information for communication with a new candidate cell based on an SRS set, which may be stored on a current active cell and/or may be stored on a UE. In such implementations, an SRS including the TA information may then be transmitted to the candidate cell, and the TA information may be used in future communication with the candidate cell. In certain implementations, the initial TA information may be further refined based on one or more signal measurements for communications received from a candidate cell (such as based on comparisons to one or more communications received from the active cell). For example, differences in timing, transmit power, and the like may be used to further determine TA information or other SRS information (such as initial transmit power or transmit beam). This may further improve the efficiencies of initially establishing communication with a new candidate cell.

Particular implementations of the subject matter described in this disclosure may be implemented to realize one or more of the following potential advantages or benefits. In some aspects, the present disclosure provides techniques for acquiring uplink timing information, such as TA information, by SRS transmission in ways that reduce the communicative overhead, complexity, and uplink resources. This information may be further refined to additionally improve the quality and efficiency of communication with candidate cells.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mm Wave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

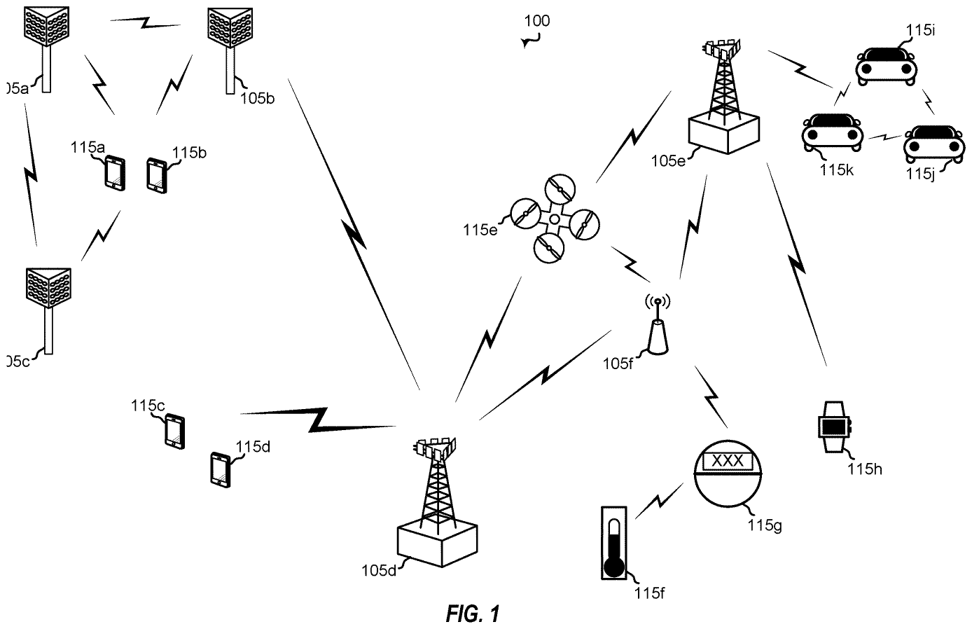

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

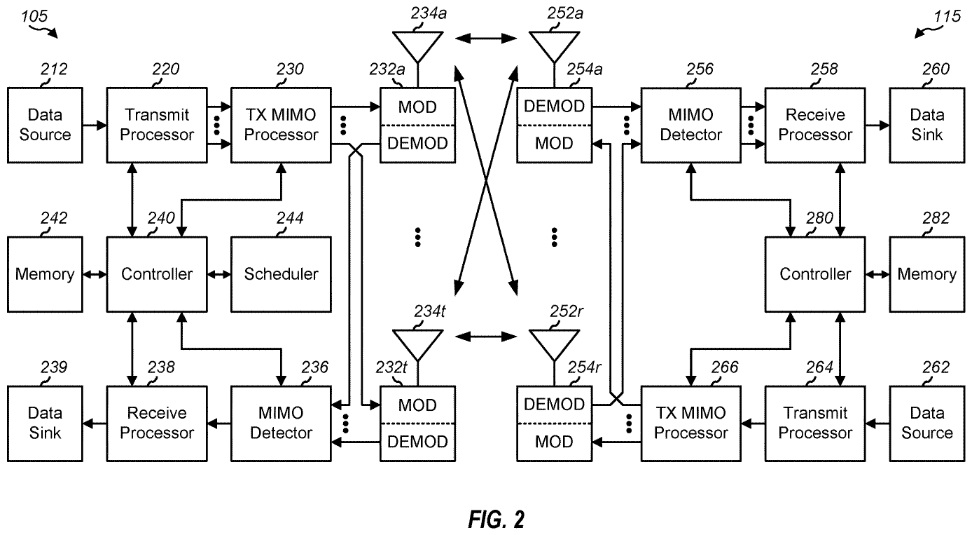

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

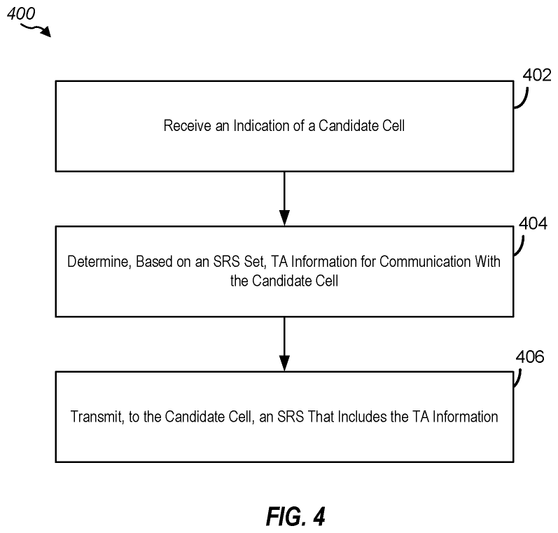

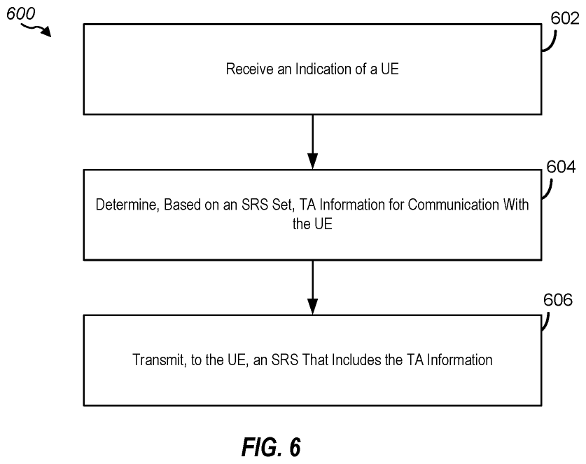

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 4 and 6, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

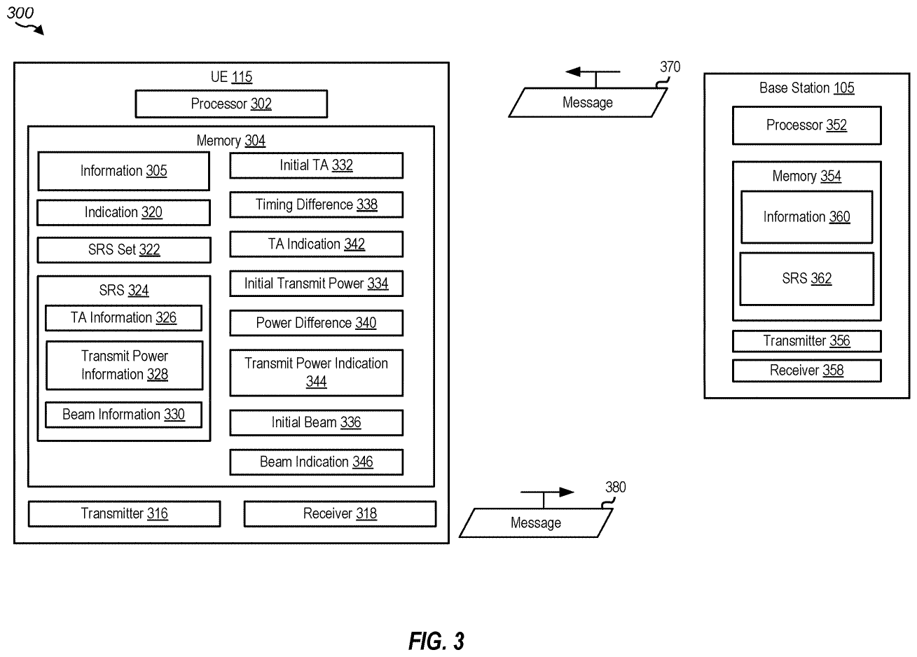

FIG. 3 is a block diagram of an example wireless communications system 300 that supports acquiring TA information for a candidate cell using a sounding reference signal (SRS) according to one or more aspects. In some examples, wireless communications system 300 may implement aspects of wireless network 100. Wireless communications system 300 includes UE 115 and base station 105. Although one UE 115 and one base station 105 are illustrated, in some other implementations, wireless communications system 300 may generally include multiple UEs 115, and may include more than one base station 105.

UE 115 may include a variety of components (such as structural, hardware components) used for carrying out one or more functions described herein. For example, these components may include one or more processors 302 (hereinafter referred to collectively as “processor 302”), one or more memory devices 304 (hereinafter referred to collectively as “memory 304”), one or more transmitters 316 (hereinafter referred to collectively as “transmitter 316”), and one or more receivers 318 (hereinafter referred to collectively as “receiver 318”). Processor 302 may be configured to execute instructions stored in memory 304 to perform the operations described herein. In some implementations, processor 302 includes or corresponds to one or more of receive processor 258, transmit processor 264, and controller 280, and memory 304 includes or corresponds to memory 282.

Memory 304 includes or is configured to store information 305, an indication 320, an SRS set 322, an SRS 324, an initial TA 332, a timing difference 338, a TA indication 342, an initial transmit power 334, a power difference 340, a transmit power indication 344, an initial beam 336, and a beam indication 346. The SRS 324 includes TA information 326, transmit power information 328, and beam information 330.

Transmitter 316 is configured to transmit reference signals, control information and data to one or more other devices, and receiver 318 is configured to receive references signals, synchronization signals, control information and data from one or more other devices. For example, transmitter 316 may transmit signaling, control information and data to, and receiver 318 may receive signaling, control information and data from, base station 105. In some implementations, transmitter 316 and receiver 318 may be integrated in one or more transceivers. Additionally or alternatively, transmitter 316 or receiver 318 may include or correspond to one or more components of UE 115 described with reference to FIG. 2.

Base station 105 may include a variety of components (such as structural, hardware components) used for carrying out one or more functions described herein. For example, these components may include one or more processors 352 (hereinafter referred to collectively as “processor 352”), one or more memory devices 354 (hereinafter referred to collectively as “memory 354”), one or more transmitters 356 (hereinafter referred to collectively as “transmitter 356”), and one or more receivers 358 (hereinafter referred to collectively as “receiver 358”). Processor 352 may be configured to execute instructions stored in memory 354 to perform the operations described herein. In some implementations, processor 352 includes or corresponds to one or more of receive processor 238, transmit processor 220, and controller 240, and memory 354 includes or corresponds to memory 242.

Memory 354 includes or is configured to store information 360 and an SRS 362.

Transmitter 356 is configured to transmit reference signals, synchronization signals, control information and data to one or more other devices, and receiver 358 is configured to receive reference signals, control information and data from one or more other devices. For example, transmitter 356 may transmit signaling, control information and data to, and receiver 358 may receive signaling, control information and data from, UE 115. In some implementations, transmitter 356 and receiver 358 may be integrated in one or more transceivers. Additionally or alternatively, transmitter 356 or receiver 358 may include or correspond to one or more components of base station 105 described with reference to FIG. 2.

In some implementations, wireless communications system 300 implements a 5G NR network. For example, wireless communications system 300 may include multiple 5G-capable UEs 115 and multiple 5G-capable base stations 105, such as UEs and base stations configured to operate in accordance with a 5G NR network protocol such as that defined by the 3GPP.

During operation of wireless communications system 300, the UE 115 may be configured to receive an indication 320 of a candidate cell. In particular, the UE 115 may be transitioning from communicating with an active cell to the candidate cell, and the indication 320 may identify the candidate cell. In certain implementations, cells may include or otherwise be implemented by a base station, such as the base station 105. In additional or alternative implementations, cells may include a portion of a service area for a base station. In certain implementations, the candidate cell may include a cell (such as a PCell, SCell, PSCell, SpCell, or combinations thereof) with which the UE 115 may be not currently communicating. For example, the UE 115 may be transitioning from a current, active cell to a new, candidate cell, such as in an L1/L2 mobility scenario. The candidate cell may be a cell selected as the next cell with which the UE 115 will communicate. For example, the UE 115 may be transitioning from an active cell implemented by a base station (not depicted) to a candidate cell implemented by the base station 105. In certain implementations, multiple cells may be capable of communicating with the UE 115 as the UE 115 moves. In such instances, the candidate cell may include multiple candidate cells. In such instances, the present techniques may be performed to identify information (such as TA information 326, beam information 330, transmit power information 328, or combinations thereof) for use in communicating with at least a subset of the multiple candidate cells.

The UE 115 may be configured to determine, based on an SRS set 322, timing advance (TA) information 326 for communication with the candidate cell. In certain implementations, TA information 326 may indicate a timing offset that the UE 115 applies to transmissions between the UE 115 and the candidate cell (such as the base station 105). In particular, the TA information 326 may indicate how much the UE 115 needs to advance uplink transmissions sent to the base station 105. The SRS set 322 may identify information regarding SRS communications between the UE 115 and the base station 105. In certain implementations, the SRS set 322 may be predetermined and may be previously stored on the UE 115. In certain implementations, the SRS set 322 may be a dedicated SRS set 322 for TA management in a candidate cell. In certain implementations, the dedicated SRS set 322 for TA management only contains TA information 326 or other timing information for one or more candidate cells.

In certain implementations, the SRS set 322 may be identified as corresponding to the candidate cell. In certain implementations, the indication 320 or other identifier of the candidate cell may correspond to the SRS set 322 (such as one or multiple predetermined SRS sets 322 stored by the UE 115). For example, the UE 115 may be configured to utilize separate SRS sets 322 for individual candidate cells. For example, the UE 115 may be configured to identify 4 candidate cells when transitioning between cells and may store separate SRS sets 322 for each candidate cell.

In certain implementations, the SRS set 322 may be configured by or based on the active cell and received by the UE 115 with the signaling from the active cell. In certain implementations, the SRS set 322 may be determined based on a previous SRS set 322 for the active cell, the previous SRS set 322 may include an SRS set 322 configured under the serving cell but associated with the candidate cell for codebook based MIMO, an SRS set 322 for non-codebook based MIMO, an SRS set 322 for positioning, an SRS set 322 for beam management, or combinations thereof. In certain implementations, the SRS set 322 may be determined based on the SRS set 322 for positioning configured under an active cell (such as a serving cell) but associated with the candidate cell. In certain implementations, the SRS set 322 may be a modified version of the previous SRS set 322. For example, the SRS set 322 may be altered based on a predefined update protocol for the previous SRS set 322 (such as a preconfigured update protocol). In certain implementations, the SRS set 322 may be updated according to a periodic transmission, a semi-persistent transmission, an aperiodic transmission, or combinations thereof. In certain implementations, the SRS set 322 may define an inter-frequency SRS with at least one of a different frequency from the previous SRS set 322, a different sub-carrier spacing (SCS) from the previous SRS set 322, a different bandwidth part (BWP) from the previous SRS set 322, or combinations thereof.

In certain implementations, the TA information 326 may be identified as corresponding to the candidate cell within the SRS set 322. In certain implementations, the indication 320 or identifier of the candidate cell may correspond to the TA information 326 within the SRS set 322. For example, the UE 115 may be configured to identify four candidate cells and may include a single SRS set 322 that contains four separate SRS resources for the four candidate cells. In such instances, the UE 115 may identify the TA information 326 based on corresponding information for the four SRS resources within the SRS set 322, such as the beam indication 320 of the candidate cell.

The UE 115 may be configured to transmit, to the candidate cell, an SRS 324 that includes the TA information 326. In certain implementations, the TA information 326 may include an initial TA 332 for use in communicating with the candidate cell. In such instances, transmitting the SRS 324 to the candidate cell may include applying the TA information 326 (such as the initial TA 332) to the SRS 324. In certain implementations, the initial TA 332 may be identified based on a TA indication 342 in a physical downlink control channel (PDCCH) signal received by the UE 115, a TA indication 342 in a medium access control (MAC) control element (CE) (“MAC-CE”) signal received by the UE 115, a TA indication 342 received in a radio resource control (RRC) indication received by the UE 115, or combinations thereof. In certain implementations, the UE 115 may receive a PDCCH and, in response to the PDCCH, may determine the TA information 326 and transmit the SRS 324 to the candidate cell. In such instances, the initial TA 332 may be identified from the PDCCH for use in transmitting the SRS 324. In additional or alternative implementations, the initial TA 332 may be contained in another message received by the UE 115, such as the MAC-CE or an RRC message. In certain implementations, such communications may be received from the active cell or another network component in the network, such as a gNodeB. In certain implementations, the initial TA 332 indication 320 may be received before, within, or after a cell switching command received by the UE 115 (such as a cell switching command to switch from the active cell to the candidate cell).

In certain implementations, the UE 115 may determine the TA information based on measurements of a message 370 received from the base station 105. For example, the UE 115 may be configured to receive a first communication from the candidate cell, determine a timing difference 338 between the first communication and a second communication received from the active cell, and determine the initial TA 332 based on the timing difference 338. In certain implementations, the timing difference 338 may include a receive-side timing difference between the first communication and the second communication. The timing difference 338 may include or otherwise be determined based on a difference in reception time between the first communication and the second communication. In certain implementations, the UE 115 may determine the initial TA 332 to compensate for the timing difference 338. In particular, the UE 115 may apply the timing difference 338 to a previous TA used for communicating with the active cell to determine the initial TA 332 for the candidate cell. Such implementations based on timing differences 338 may be used for instances where the UE 115 does not receive an initial TA 332 Indication from a gNodeB.

In certain implementations, the SRS 324 may include additional information beyond the TA information 326. For example, the SRS 324 may specify beam information 330 (such as beam management information), transmit power information 328, or combinations thereof. In certain implementations, the SRS 324 further may include an initial transmit power 334 for use in communicating with the candidate cell. In such instances, transmitting the SRS 324 to the candidate cell may include applying the initial transmit power 334 to the SRS 324. In certain implementations, the initial transmit power 334 may be identified based on a transmit power indication 344 in a PDCCH received by the UE 115, a transmit power indication 344 in a MAC-CE received by the UE 115, a transmit power indication 344 received in an RRC indication 320 received by the UE 115, or combinations thereof. In certain implementations, the UE 115 may receive a PDCCH and, in response to the PDCCH, may determine the TA information 326, determine the initial transmit power 334, and transmit the SRS 324 containing power information 328 to the candidate cell (such as to the base station 105). In such instances, the initial transmit power 334 may be identified from the PDCCH (such as from a transmit power indication 344 within the PDCCH). In additional or alternative implementations, the initial transmit power 334 may be contained in another message received by the UE 115, such as the MAC-CE or an RRC message (such as in a transmit power indication 344 contained in such messages). In certain implementations, such communications may be received from the active cell or another network component in the network, such as a gNodeB. In certain implementations, the transmit power indication 344 may include a target received power, a close loop index, an alpha value, a transmit power command, a power delta value, or combinations thereof. In certain implementations, the initial transmit power indication 344 may be received before, within, or after a cell switching command received by the UE 115 (such as a cell switching command to switch from the active cell to the candidate cell).

In certain implementations, the UE 115 may be configured to determine the initial transmit power 334 based on one or more signal measurements. For example, the UE 115 may be configured to receive a first communication from the candidate cell, determine a power difference 340 between the first communication and a second communication received from the active cell, and determine the initial transmit power 334 based on the power difference 340. In certain implementations, the power difference 340 may include a path loss difference between the first and second communications, such as a difference in received power between the first communication and the second communication. In certain implementations, the UE 115 may determine the initial TA 332 to compensate for the path loss difference. In particular, the UE 115 may apply the power difference 340 to a previous transmit power used for communicating with the active cell to determine the initial transmit power 334 for the candidate cell. Such implementations based on power difference 340 may be used for instances where the UE 115 does not receive an initial transmit power indication 344 from a gNodeB.

In certain implementations, the SRS 324 further may include an initial beam 336 for use in communicating with the candidate cell. In such instances, the SRS 324 may be transmitted to the candidate cell using the initial beam 336. In certain implementations, the initial beam 336 may be identified based on a beam indication 346 in a PDCCH received by the UE 115, a beam indication 346 in a MAC-CE received by the UE 115, a beam indication 346 received in an RRC indication 320 received by the UE 115, or combinations thereof. In certain implementations, the UE 115 may receive a PDCCH and, in response to the PDCCH, may determine the TA information 326, determine the initial beam 336, and transmit the SRS 324 to the candidate cell. In such instances, the initial beam 336 may be identified from the PDCCH for use in transmitting the SRS 324. In additional or alternative implementations, the initial beam 336 may be contained in another message received by the UE 115, such as the MAC-CE or an RRC message, such as in a beam indication 346 contained in the message. In certain implementations, such communications may be received from the active cell or another network component in the network, such as a gNodeB. In certain implementations, the beam indication 346 may include a unified transmission configuration indicator (TCI) (such as a joint TCI, an uplink TCI, or combinations thereof), legacy spatial relation information, or combinations thereof. In certain implementations, the beam indication 346 may be received before, within, or after a cell switching command received by the UE 115 (such as a cell switching command to switch from the active cell to the candidate cell).

In certain implementations, the UE 115 and the candidate cell may continue communicating according to the SRS 324 (such as according to the TA information 326, beam information 330, transmit power information 328, or combinations thereof identified by the SRS 324). In additional or alternative implementations, the UE 115 and the candidate cell may subsequently communicate to establish updated TA information 326 for future communications.

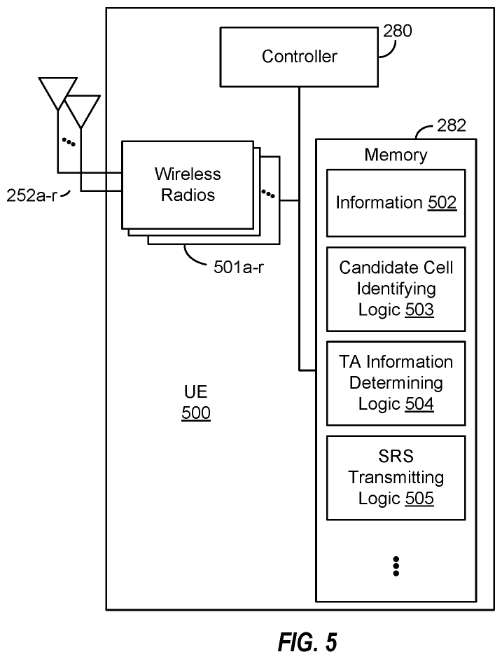

The above techniques were discussed as being performed by the UE 115. In various implementation, one skilled in the art will appreciate that all or part of these techniques may be performed by a base station 105, such as by the candidate cell. For example, such implementations are discussed in greater detail in connection with FIG. 5 below.

As described with reference to FIG. 3, the present disclosure provides techniques for acquiring uplink timing information, such as TA information, by SRS transmission in ways that reduce the communicative overhead, complexity, and uplink resources. This information may be further refined to additionally improve the quality and efficiency of communication with candidate cells.

FIG. 4 is a flow diagram illustrating an example process 400 that supports acquiring TA information for a candidate cell using an SRS 324 according to one or more aspects. Operations of process 400 may be performed by a UE 115, such as UE 115 115 described above with reference to FIGS. 1, 2, 3, or a UE 115 described with reference to FIG. 5. For example, example operations (also referred to as “blocks”) of process 400 may enable UE 115 to support acquiring TA information for a candidate cell using an SRS 324.

The process 400 includes receiving an indication of a candidate cell (block 402). For example, the UE 115 may receive an indication 320 of a candidate cell. The UE 115 may be transitioning from communicating with an active cell to the candidate cell and may receive the indication 320 as part of the transition, such as in an L1/L2 mobility scenario.

The process 400 includes determining, based on an SRS set, timing advance (TA) information for communication with the candidate cell (block 404). For example, the UE 115 may determine, based on an SRS set 322, TA information 326 for communication with the candidate cell. In certain implementations, the SRS set 322 may be predetermined and previously stored on the UE 115. In certain implementations, the SRS set 322 may be identified as corresponding to the candidate cell. For example, the indication 320 or other identifier of the candidate cell may correspond to the SRS set 322 (such as one or multiple predetermined SRS sets 322 stored by the UE 115). The SRS set 322 may be a dedicated SRS set 322 for TA management. In certain implementations, the SRS set 322 may be configured by or based on the active cell and received by the UE 115 from the active cell. For example, the SRS set 322 may be determined based on a previous SRS set 322 for the active cell, such as an SRS set 322 for codebook based MIMO with the active cell, an SRS set 322 for non-codebook based MIMO with the active cell, an SRS set 322 for positioning with the active cell, an SRS set 322 for beam management with the active cell, or combinations thereof. For example, the SRS set 322 may be determined based on the SRS set 322 for positioning with the active cell. In certain implementations, the SRS set 322 may be a modified version of the previous SRS set 322. For example, the SRS set 322 may be altered based on a predefined update protocol for the previous SRS set 322 (such as a preconfigured update protocol). In certain implementations, the indication 320 or another identifier of the candidate cell may correspond to the TA information 326 within the SRS set 322.

The process 400 includes transmitting, to the candidate cell, an SRS that includes the TA information (block 406). For example, the UE 115 may transmit, to the candidate cell, an SRS 324 that includes the TA information 326. In certain implementations, the TA information 326 may include an initial TA 332 for use in communicating with the candidate cell. In such instances, transmitting the SRS 324 to the candidate cell may include applying the TA information 326 to the SRS 324. In certain implementations, the initial TA 332 may be identified based on a TA indication 320 in a PDCCH received by the UE 115, a TA indication 320 in a MAC-CE received by the UE 115, a TA indication 320 received in an RRC indication 320 received by the UE 115, or combinations thereof. In certain implementations, the method may further include receiving a first communication from the candidate cell, determining a timing difference 338 between the first communication and a second communication received from the active cell, and determining the initial TA 332 based on the timing difference 338. For example, the timing difference 338 may include a receive-side timing difference 338 between the first communication and the second communication and the initial TA 332 may be determined to compensate for the timing difference 338.

In certain implementations, the SRS 324 may include additional information beyond the TA information 326. For example, the SRS 324 may specify beam information 330, power information 328, or combinations thereof. For example, the SRS 324 may include an initial transmit power 334 for use in communicating with the candidate cell. In such instances, transmitting the SRS 324 to the candidate cell may include applying the initial transmit power 334 to the SRS 324. In certain implementations, the initial transmit power 334 may be identified based on a transmit power indication 344 in a PDCCH received by the UE 115, a transmit power indication 344 in a MAC-CE received by the UE 115, a transmit power indication 344 in an RRC indication received by the UE 115, or combinations thereof. In certain implementations, the method may further include receiving a first communication from the candidate cell, determining a power difference 340 between the first communication and a second communication received from the active cell, and determining the initial transmit power 334 based on the power difference 340. For example, the UE 115 may determine the initial transmit power 334 to compensate for the power difference 340.

In certain implementations, the SRS 324 further may include an initial beam 336 for use in communicating with the candidate cell. In such instances, the SRS 324 may be transmitted to the candidate cell using the initial beam 336. In certain implementations, the initial beam 336 may be identified based on a beam indication 346 in a PDCCH received by the UE 115, a beam indication 346 in a MAC-CE received by the UE 115, a beam indication 346 in an RRC indication 320 received by the UE 115, or combinations thereof. For example, the beam indication 346 may include a unified TCI legacy spatial relation information, or combinations thereof.

The UE 115 and the candidate cell may continue 115 communicating according to the SRS 324 (such as according to the TA information 326, beam information 330, transmit power information 328, or combinations thereof identified by the SRS 324). In additional or alternative implementations, the UE 115 and the candidate cell may subsequently communicate to establish updated TA information 326 for future communications.

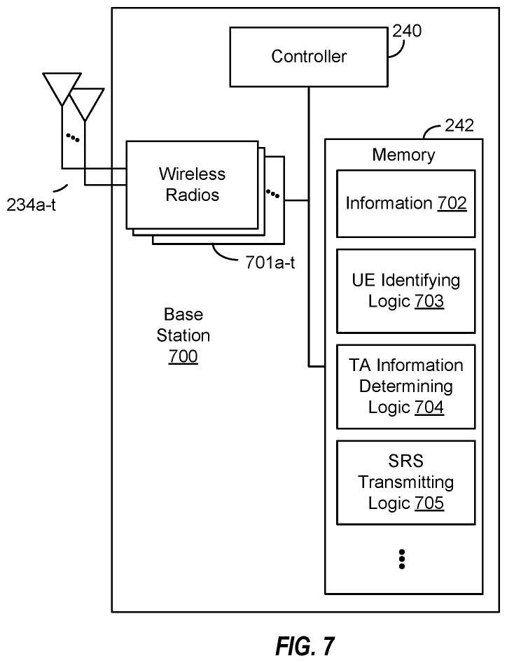

FIG. 5 is a block diagram of an example UE 500 that supports acquiring TA information for a candidate cell using an SRS 324 to one or more aspects. UE 500 may be configured to perform operations, including the blocks of a process described with reference to FIG. 4 or 6. In some implementations, UE 500 includes the structure, hardware, and components shown and described with reference to UE 115 of FIGS. 1-3. For example, UE 500 includes controller 280, which operates to execute logic or computer instructions stored in memory 282, as well as controlling the components of UE 500 that provide the features and functionality of UE 500. UE 500, under control of controller 280, transmits and receives signals via wireless radios 501a-r and antennas 252a-r. Wireless radios 501a-r include various components and hardware, as illustrated in FIG. 2 for UE 115, including modulator and demodulators 254a-r, MIMO detector 256, receive processor 258, transmit processor 264, and TX MIMO processor 266. UE 500 may receive signals from or transmit signals to one or more network entities, such as base station 105 of FIGS. 1-3 or a base station as illustrated in FIG. 7.

As shown, memory 282 may include information 502, candidate cell identification logic 503, TA information determining logic 504, and SRS transmitting logic 505. The candidate cell identification logic 503 may be configured to receive an indication of a candidate cell. For example, the candidate cell identification logic 503 may receive, via the wireless radios 501a-r and antennas 252a-r, an indication 320 of a candidate cell. The UE 500 may be transitioning from communicating with an active cell to the candidate cell and may receive the indication 320 as part of the transition, such as in an L1/L2 mobility scenario.

The TA information determining logic 504 may be configured to determine, based on an SRS set, TA information for communication with the candidate cell. For example, the TA information determining logic 504 may determine, based on an SRS set 322, TA information 326 for communication with the candidate cell. In certain implementations, the SRS set 322 may be predetermined and previously stored on the UE 115. In certain implementations, the SRS set 322 may be identified as corresponding to the candidate cell. In certain implementations, the SRS set 322 may be defined by the active cell and received by the UE 115 from the active cell. For example, the SRS set 322 may be determined based on a previous SRS set 322 for the active cell. In certain implementations, the SRS set 322 may be a modified version of the previous SRS set 322. For example, the SRS set 322 may be altered based on a predefined update protocol for the previous SRS set 322 (such as a preconfigured update protocol). In certain implementations, the indication 320 or another identifier of the candidate cell may correspond to the TA information 326 within the SRS set 322.

The SRS transmitting logic 505 may be configured to transmit, to the candidate cell, an SRS that includes the TA information (block 406). For example, the UE 115 may transmit, wireless radios 501a-r and antennas 252a-r an SRS 324 to the candidate cell that includes the TA information 326. In certain implementations, the TA information 326 may include an initial TA 332 for use in communicating with the candidate cell. In such instances, transmitting the SRS 324 to the candidate cell may include applying the TA information 326 to the SRS 324. In certain implementations, the initial TA 332 may be identified based on a TA indication 320 received by the UE 500. For example, the initial TA 332 may be determined by the TA information determining logic 504 based on one or more messages received by the UE 500, as explained further above.

In certain implementations, the SRS 324 may include additional information beyond the TA information 326. For example, the SRS 324 may specify beam information 330, power information 328, or combinations thereof. In such implementations, the TA information determining logic 504, or other logic of the UE 500 may be configured to determine the additional information 330, 328 based on one or more received messages, as explained further above.

FIG. 6 is a flow diagram illustrating an example process 600 that supports acquiring TA information for a candidate cell using an SRS 324 according to one or more aspects. Operations of process 600 may be performed by a base station, such as base station 105 described above with reference to FIGS. 1-3 or a base station as described above with reference to FIG. 7. For example, example operations of process 600 may enable base station 105 to support acquiring TA information for a candidate cell using an SRS 324.

The process 600 includes receiving an indication of a UE (block 602). For example, the base station 105 may receive an indication 320 of a UE 115. The UE 115 may be transitioning from communicating with a second base station 105 to the first base station 105.

The process 600 includes determining, based on an SRS set, timing advance (TA) information for communication with the UE (block 604). For example, the base station 105 may determine, based on an SRS set 322, TA information for communication with the UE 115. In certain implementations, the SRS set 322 may be predetermined and previously stored on the first base station. In certain implementations, the SRS set 322 may be identified as corresponding to the UE 115. In certain implementations, the SRS set 322 may be a dedicated SRS set 322 for TA management. In certain implementations, the SRS set 322 may be defined by the second base station and may be received by the first base station 105 from the second base station. In certain implementations, the SRS set 322 may be determined based on a previous SRS set 322 for the second base station, the previous SRS set 322 may include an SRS set 322 for codebook based MIMO with the second base station, an SRS set 322 for non-codebook based MIMO with the second base station, an SRS set 322 for positioning with the second base station, an SRS set 322 for beam management with the second base station, or combinations thereof. For example, the SRS set 322 may be determined based on the SRS set 322 for positioning with second first base station 105. In certain implementations, the TA information 326 may be identified as corresponding to the first base station 105 within the SRS set 322.

The process 600 includes transmitting, to the UE, an SRS that includes the TA information (block 606). For example, the base station 105 may transmit, to the UE 115, an SRS 324 that includes the TA information 326. In certain implementations, the TA information 326 may include an initial TA 332 for use in communicating between the UE 115 and the first base station 105. In such instances, transmitting the SRS 324 to the UE 115 may include applying the TA information 326 to the SRS 324. In certain implementations, the initial TA 332 may be identified based on a TA indication 320 in a PDCCH received by the first base station 105, a TA indication 320 in a MAC-CE received by the first base station 105, a TA indication 320 received in an RRC indication 320 received by the first base station 105, or combinations thereof.

In certain implementations, the SRS 324 further may include an initial transmit power 334 for use in communicating with the UE 115. In such instances, transmitting the SRS 324 to the UE 115 may include applying the initial transmit power 334 to the SRS 324. In certain implementations, the initial transmit power 334 may be identified based on a transmit power indication 320 344 in a PDCCH received by the first base station 105, a transmit power indication 320 344 in a MAC-CE received by the first base station 105, a transmit power indication 320 344 in an RRC indication 320 received by the first base station 105, or combinations thereof.

In certain implementations, the SRS 324 may further include an initial beam 336 for use in communicating with the UE 115. In such instances, the SRS 324 may be transmitted to the UE 115 using the initial beam 336. In certain implementations, the initial beam 336 may be identified based on a beam indication 320 346 in a PDCCH received by the first base station 105, a beam indication 320 346 in a MAC-CE received by the first base station 105, a beam indication 346 in an RRC indication 320 received by the first base station 105, or combinations thereof.

FIG. 7 is a block diagram of an example base station 700 that supports acquiring TA information for a candidate cell using an SRS 324 according to one or more aspects. Base station 700 may be configured to perform operations, including the blocks of process 600 described with reference to FIG. 4 or 6. In some implementations, base station 700 includes the structure, hardware, and components shown and described with reference to base station 105 of FIGS. 1-3. For example, base station 700 may include controller 240, which operates to execute logic or computer instructions stored in memory 242, as well as controlling the components of base station 700 that provide the features and functionality of base station 700. Base station 700, under control of controller 240, transmits and receives signals via wireless radios 701a-t and antennas 734a-t. Wireless radios 701a-t include various components and hardware, as illustrated in FIG. 2 for base station 105, including modulator and demodulators 232a-t, transmit processor 220, TX MIMO processor 230, MIMO detector 236, and receive processor 238.

As shown, memory 242 may include information 702, UE identification logic 703, TA information determining logic 704, and SRS transmitting logic 705. The UE identification logic 703 may be configured to receive an indication of a UE. For example, the candidate cell identification logic 703 may receive an indication 320 of a UE 115, 500. The UE 115, 500 may be transitioning from communicating with a second base station to the base station 700.

The TA information determining logic 704 may be configured to determine, based on an SRS set, TA information for communication with the UE. For example, the TA information determining logic 704 may determine, based on an SRS set 322, TA information 326 for communication with the UE 115. In certain implementations, the SRS set 322 may be predetermined and previously stored on the base station 700. In certain implementations, the SRS set 322 may be identified as corresponding to the UE 115. In certain implementations, the SRS set 322 may be a dedicated SRS set 322 for TA management. In certain implementations, the SRS set 322 may be defined by the second base station and may be received by the base station 700 from the second base station. In certain implementations, the SRS set 322 may be determined based on a previous SRS set 322 for the second base station, the previous SRS set 322 may include an SRS set 322 for codebook based MIMO with the second base station, an SRS set 322 for non-codebook based MIMO with the second base station, an SRS set 322 for positioning with the second base station, an SRS set 322 for beam management with the second base station, or combinations thereof. For example, the SRS set 322 may be determined based on the SRS set 322 for positioning with second base station. In certain implementations, the TA information 326 may be identified as corresponding to the first base station 700 within the SRS set 322.

The SRS transmitting logic 705 may be configured to transmit, to the UE, an SRS that includes the TA information. For example, the base station 105 may transmit, to the UE 115, 500, an SRS 324 that includes the TA information 326. In certain implementations, the TA information 326 may include an initial TA 332 for use in communicating between the UE 115, 500 and the first base station 700. In such instances, transmitting the SRS 324 to the UE 115, 500 may include applying the TA information 326 to the SRS 324. In certain implementations, the initial TA 332 may be identified based on a TA indication 320 in a PDCCH received by the first base station 700, a TA indication 320 in a MAC-CE received by the first base station 700, a TA indication 320 received in an RRC indication 320 received by the first base station 700, or combinations thereof. In certain implementations, the SRS 324 may include additional information beyond the TA information 326. For example, the SRS 324 may specify beam information 330, power information 328, or combinations thereof. In such implementations, the TA information determining logic 704, or other logic of the base station 700 may be configured to determine the additional information 330, 328 based on one or more received messages, as explained further above.

It is noted that one or more blocks (or operations) described with reference to FIG. 4 or 6 may be combined with one or more blocks (or operations) described with reference to another of the figures. For example, one or more blocks (or operations) of FIG. 4 may be combined with one or more blocks (or operations) of FIG. 6. As another example, one or more blocks associated with FIG. 6 may be combined with one or more blocks associated with FIG. 4. As another example, one or more blocks associated with FIGS. 4 and 6 may be combined with one or more blocks (or operations) associated with FIGS. 1-3. Additionally, or alternatively, one or more operations described above with reference to FIGS. 1-3 may be combined with one or more operations described with reference to FIG. 5 or 7.

In one or more aspects, techniques for supporting acquiring TA information for a candidate cell using an SRS may include additional aspects, such as any single aspect or any combination of aspects described below or in connection with one or more other processes or devices described elsewhere herein. In a first aspect, the techniques described herein relate to a method of wireless communication performed by a user equipment (UE), the method including receiving an indication of a candidate cell, wherein the UE is transitioning from communicating with an active cell to the candidate cell; determining, based on a sounding reference signal (SRS) set, timing advance (TA) information for communication with the candidate cell; and transmitting, to the candidate cell, an SRS that includes the TA information.

In a second aspect according to the first aspect, the TA information includes an initial TA for use in communicating with the candidate cell, and wherein transmitting the SRS to the candidate cell includes applying the TA information to the SRS.

In a third aspect according to the second aspect, the initial TA is identified based on a first TA indication in a PDCCH received by the UE, a second TA indication in a MAC-CE received by the UE, a third TA indication received in an RRC indication received by the UE, or combinations thereof.

In a fourth aspect according to at least one of the second through third aspects, the method further includes receiving a first communication from the candidate cell, determining a timing difference between the first communication and a second communication received from the active cell, and determining the initial TA based on the timing difference.

In a fifth aspect according to at least one of the first through fourth aspects, the SRS further includes an initial transmit power for use in communicating with the candidate cell, and wherein transmitting the SRS to the candidate cell includes applying the initial transmit power to the SRS.

In a sixth aspect according to the fifth aspect, the initial transmit power is identified based on a first transmit power indication in a physical downlink control channel (PDCCH) received by the UE, a second transmit power indication in a medium access control (MAC) control element (MAC-CE) received by the UE, a third transmit power indication received in a radio resource control (RRC) indication received by the UE, or combinations thereof.

In a seventh aspect according to at least one of the fifth through sixth aspects, the method further includes receiving a first communication from the candidate cell; determining a path loss difference between the first communication and a second communication received from the active cell; and determining the initial transmit power based on the path loss difference.

In an eighth aspect according to at least one of the first through seventh aspects, the SRS further includes an initial beam for use in communicating with the candidate cell, and wherein the SRS is transmitted to the candidate cell using the initial beam.

In a ninth aspect according to the eighth aspect, the initial beam is identified based on a first beam indication in a PDCCH received by the UE, a second beam indication in a MAC-CE received by the UE, a third beam indication received in an RRC indication received by the UE, or combinations thereof.

In a tenth aspect according to at least one of the first through ninth aspects, the SRS set is predetermined and previously stored on the UE.

In a eleventh aspect according to at least one of the first through tenth aspects, the SRS set is identified as corresponding to the candidate cell.

In a twelfth aspect according to at least one of the first through eleventh aspects, the SRS set is a dedicated SRS set for TA management.

In a thirteenth aspect according to at least one of the first through twelfth aspects, the SRS set is determined by the active cell and received by the UE from the active cell.

In a fourteenth aspect according to the thirteenth aspect, the SRS set is determined based on a previous SRS set for the active cell, wherein the previous SRS set includes a first previous SRS set for codebook based MIMO with the active cell, a second previous SRS set for non-codebook based MIMO with the active cell, a third previous SRS set for positioning with the active cell, an SRS set for beam management with the active cell, or combinations thereof.

In a fifteenth aspect according to the fourteenth aspect, the SRS set is determined based on the third previous SRS set for positioning with the active cell.

In a sixteenth aspect according to at least one of the first through fifteenth aspects, the TA information is identified as corresponding to the candidate cell within the SRS set.

In a seventeenth aspect, the techniques described herein relate to a method of wireless communication performed by a first base station, the method including receiving an indication of a UE, wherein the UE is transitioning from communicating with a second base station to the first base station; determining, based on a sounding reference signal (SRS) set, timing advance (TA) information for communication with the UE; and transmitting, to the UE, an SRS that includes the TA information.

In an eighteenth aspect according to seventeenth aspect, the TA information includes an initial TA for use in communicating with the first base station, and wherein transmitting the SRS to the UE includes applying the TA information to the SRS.

In a nineteenth aspect according to at least one of the seventeenth through eighteenth aspects, the SRS further includes an initial transmit power for use in communicating with the UE, and wherein transmitting the SRS to the UE includes applying the initial transmit power to the SRS.

In a twentieth aspect according to at least one of the seventeenth through nineteenth aspects, the SRS further includes an initial beam for use in communicating with the UE, and wherein the SRS is transmitted to the UE using the initial beam.

In a twenty-first aspect according to at least one of the seventeenth through twentieth aspects, the SRS set is identified as corresponding to the UE.

In a twenty-second aspect according to at least one of the seventeenth through twenty-second aspects, the SRS set is predetermined and previously stored on the first base station.

In a twenty-third aspect, the techniques described herein relate to a user equipment (UE) including a memory storing processor-readable code; and at least one processor coupled to the memory, the at least one processor configured to execute the processor-readable code to cause the at least one processor to receive an indication of a candidate cell, wherein the UE is transitioning from communicating with an active cell to the candidate cell; determine, based on a sounding reference signal (SRS) set, timing advance (TA) information for communication with the candidate cell; and transmit, to the candidate cell, an SRS that includes the TA information. Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a twenty-fourth aspect to the twenty-second aspect, the TA information includes an initial TA for use in communicating with the candidate cell, and wherein transmitting the SRS to the candidate cell includes applying the TA information to the SRS.

In a twenty-fifth aspect according to the twenty-fourth aspect, executing the processor-readable code further causes the at least one processor to receive a first communication from the candidate cell; determine a timing difference between the first communication and a second communication received from the active cell; and determine the initial TA based on the timing difference.

In a twenty-sixth aspect according to any one of the twenty-third through twenty-fifth aspects, the SRS further includes an initial transmit power for use in communicating with the candidate cell, and wherein transmitting the SRS to the candidate cell includes applying the initial transmit power to the SRS.

In a twenty-seventh aspect according to any one of the twenty-third through twenty-sixth aspects, the SRS further includes an initial beam for use in communicating with the candidate cell, and the SRS is transmitted to the candidate cell using the initial beam.

In a twenty-eighth aspect, the techniques described herein relate to a first base station including a memory storing processor-readable code; and at least one processor coupled to the memory, the at least one processor configured to execute the processor-readable code to cause the at least one processor to receive an indication of a UE, wherein the UE is transitioning from communicating with a second base station to the first base station; determine, based on a sounding reference signal (SRS) set, timing advance (TA) information for communication with the UE; and transmit, to the UE, an SRS that includes the TA information. Additionally, the apparatus may perform or operate according to one or more aspects as described below. In some implementations, the apparatus includes a wireless device, such as a base station. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a twenty-ninth aspect according to the twenty-eighth aspect, the TA information includes an initial TA for use in communicating with the first base station, and wherein transmitting the SRS to the UE includes applying the TA information to the SRS.

In a thirtieth aspect according to any one of the twenty-eighth through twenty-ninth aspects, the SRS further includes an initial transmit power for use in communicating with the UE, and wherein transmitting the SRS to the UE includes applying the initial transmit power to the SRS.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-3, 5, and 7 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of wireless communication performed by a user equipment (UE), the method comprising:
receiving an indication of a candidate cell, wherein the UE is transitioning from communicating with an active cell to the candidate cell;
determining, based on a sounding reference signal (SRS) set, timing advance (TA) information for communication with the candidate cell; and
transmitting, to the candidate cell, an SRS that includes the TA information.

2. The method of claim 1, wherein the TA information includes an initial TA for use in communicating with the candidate cell, and wherein transmitting the SRS to the candidate cell includes applying the TA information to the SRS.

3. The method of claim 2, wherein the initial TA is identified based on a first TA indication in a physical downlink control channel (PDCCH) received by the UE, a second TA indication in a medium access control (MAC) control element (MAC-CE) received by the UE, a third TA indication received in a radio resource control (RRC) indication received by the UE, or combinations thereof.

4. The method of claim 2, further comprising:
receiving a first communication from the candidate cell;
determining a timing difference between the first communication and a second communication received from the active cell; and
determining the initial TA based on the timing difference.

5. The method of claim 1, wherein the SRS further includes an initial transmit power for use in communicating with the candidate cell, and wherein transmitting the SRS to the candidate cell includes applying the initial transmit power to the SRS.

6. The method of claim 5, wherein the initial transmit power is identified based on a first transmit power indication in a physical downlink control channel (PDCCH) received by the UE, a second transmit power indication in a medium access control (MAC) control element (MAC-CE) received by the UE, a third transmit power indication received in a radio resource control (RRC) indication received by the UE, or combinations thereof.

7. The method of claim 5, further comprising:
receiving a first communication from the candidate cell;
determining a path loss difference between the first communication and a second communication received from the active cell; and
determining the initial transmit power based on the path loss difference.

8. The method of claim 1, wherein the SRS further includes an initial beam for use in communicating with the candidate cell, and wherein the SRS is transmitted to the candidate cell using the initial beam.

9. The method of claim 8, wherein the initial beam is identified based on a first beam indication in a physical downlink control channel (PDCCH) received by the UE, a second beam indication in a medium access control (MAC) control element (MAC-CE) received by the UE, a third beam indication received in a radio resource control (RRC) indication received by the UE, or combinations thereof.

10. The method of claim 1, wherein the SRS set is predetermined and previously stored on the UE.

11. The method of claim 1, wherein the SRS set is identified as corresponding to the candidate cell.

12. The method of claim 1, wherein the SRS set is a dedicated SRS set for TA management.

13-22. (canceled)

23. A user equipment (UE) comprising:
a memory storing processor-readable code; and
at least one processor coupled to the memory, the at least one processor configured to execute the processor-readable code to cause the at least one processor to:
receive an indication of a candidate cell, wherein the UE is transitioning from communicating with an active cell to the candidate cell;
determine, based on a sounding reference signal (SRS) set, timing advance (TA) information for communication with the candidate cell; and
transmit, to the candidate cell, an SRS that includes the TA information.

24. The UE of claim 23, wherein the TA information includes an initial TA for use in communicating with the candidate cell, and wherein transmitting the SRS to the candidate cell includes applying the TA information to the SRS.

25. The UE of claim 24, wherein executing the processor-readable code further causes the at least one processor to:
receive a first communication from the candidate cell;
determine a timing difference between the first communication and a second communication received from the active cell; and
determine the initial TA based on the timing difference.

26. The UE of claim 23, wherein the SRS further includes an initial transmit power for use in communicating with the candidate cell, and wherein transmitting the SRS to the candidate cell includes applying the initial transmit power to the SRS.

27. The UE of claim 23, wherein the SRS further includes an initial beam for use in communicating with the candidate cell, and wherein the SRS is transmitted to the candidate cell using the initial beam.

28. A first base station comprising:
a memory storing processor-readable code; and
at least one processor coupled to the memory, the at least one processor configured to execute the processor-readable code to cause the at least one processor to:
receive an indication of a UE, wherein the UE is transitioning from communicating with a second base station to the first base station;
determine, based on a sounding reference signal (SRS) set, timing advance (TA) information for communication with the UE; and
transmit, to the UE, an SRS that includes the TA information.

29. The first base station of claim 28, wherein the TA information includes an initial TA for use in communicating with the first base station, and wherein transmitting the SRS to the UE includes applying the TA information to the SRS.

30. The first base station of claim 28, wherein the SRS further includes an initial transmit power for use in communicating with the UE, and wherein transmitting the SRS to the UE includes applying the initial transmit power to the SRS.
